(19) United States
(12) Patent Application Publication
(10) Pub. No.: US 2014/0166552 A1
(43) Pub. Date: Jun. 19, 2014

(54) AIR SEPARATOR WITH PLENUM

(71) Applicant: LAITRAM, L.L.C., Harahan, LA (US)

(72) Inventors: Robert S. Lapeyre, New Orleans, LA (US); Christopher G. Greve, Covington, LA (US)

(73) Assignee: LAITRAM, L.L.C., Harahan, LA (US)

(21) Appl. No.: 13/714,041

(22) Filed: Dec. 13, 2012

(51) Int. Cl. B07B 4/00

(52) U.S. Cl. CPC B07B 4/00
USPC 209/644

(57) ABSTRACT

Apparatus and method for separating lightweight waste from product with air supplied by a plenum. An air separator includes a blower duct directing air upward through product conveyed on a foraminous conveyor. The blower duct is in communication with a plenum through an opening. One or more blowers fill and pressurize the plenum with air without blowing the air directly through the opening. The drop in pressure from the plenum to the exit end of the duct draws air uniformly through the opening and into the duct. The uniform flow of air through the duct and the conveyor lifts lightweight waste from the product.

### BACKGROUND

The invention relates generally to separating waste material from product and more particularly to apparatus and methods for separating lightweight waste from heavier product with air supplied from a plenum.

Air separators are used in the processing of many raw materials to separate lightweight debris and other materials from a product. Some examples include winnowing chaff from grain, separating coal into fines, shelling nuts, and separating loose shell and appendages from peeled shrimp meats. In the shrimp-processing industry, for example, machine-peeled shrimp are conveyed on a foraminous conveyor belt from a peeler to a cooker or packaging station. Although most of the shells, heads, and other appendages that are removed in the peeler are also washed away, some bits adhere to the peeled shrimp meats. The shrimp meats are conveyed through an air separator, which blows air up from a blower duct through the meats on the conveyor to lift the lighter shell and appendage peelings from the shrimp meats. The air flow carries the waste peelings away in a waste conveyor duct above the conveyor to a waste separation chamber in which the waste materials settle and are collected for disposal.

Conventional air separators have blowers, or fans, that produce a constant air flow whose speed may be modulated or unmodulated. A rotating paddle, or vane, in the blower duct of some air separators is used to modulate the air speed to produce a pulsating air flow. The speed of the air varies between a minimum speed when the vane is closed to block the duct and a maximum speed when the vane is open. With air-flow modulation, smaller and less noisy blowers can be used to achieve higher maximum speeds than with a constant, unmodulated flow. The higher air speeds improve the separation of the peelings from the meats.

One of the problems with conventional air separators, especially those for use with wet and slimy product like shrimp, is that the waste peelings can stick to the walls of the waste conveyor duct, necessitating frequent cleaning to keep the duct clear for effective separation. Another problem is uneven airflow across the entire segment of the conveyor over the duct.

### SUMMARY

One version of an air separator embodying features of the invention for separating lightweight waste from product comprises a duct having an upper exit proximate the underside of a conveyor conveying product in a conveying direction. A plenum adjacent the duct is in communication with the duct through an opening into the duct. One or more blowers direct air into the plenum along a flow path that does not extend to the opening. The blowers pressurize the plenum so that the drop in pressure from the plenum to the upper exit of the duct draws air through the opening and through the first duct and the conveyor to blow lightweight waste upward from the product.

According to another aspect of the invention, a method for separating lightweight waste from product comprises: (a) conveying product over the exit end of the duct of an air separator on a foraminous conveyor belt; (b) pressurizing a plenum by blowing air into the plenum along an initial flow path not extending to an opening from the plenum into an entrance end of the duct; and (c) blowing lightweight waste upward from the product by drawing air through the opening and through the duct and the foraminous conveyor by the drop in pressure from the pressurized plenum to the upper exit of the duct.

### BRIEF DESCRIPTION OF THE DRAWINGS

These features and aspects of the invention, as well as its advantages, are better understood by referring to the following description, appended claims, and accompanying drawings, in which:

FIG. 1 is a perspective view of an air separator embodying features of the invention;

FIG. 2 is a perspective view of the blower assembly of the air separator viewed from the opposite side of FIG. 1;

FIG. 3 is a side elevation view, partly cut away, of the air separator of FIG. 1;

FIG. 4 is a perspective view from below of the flow modulation vanes in the top of the blower duct of the air separator of FIG. 1;

FIG. 5 is a perspective view of one version of a vane drive mechanism in the air separator of FIG. 1;

FIGS. 6A-6D are side elevation views of the blower duct showing the cyclic operation of the vanes of FIG. 4;

FIG. 7 is a side elevation view of another version of a vane drive mechanism using a variable speed motor drive for the vanes;

FIG. 8 is a block diagram of a control system for the air separator of FIG. 1;

FIG. 9 is a side elevation view of the lower blower assembly of an air separator as in FIG. 1 embodying features of the invention including plenum-supplied air;

FIG. 10 is an oblique view of the lower blower assembly of FIG. 9; and

FIG. 11 is a second oblique view of the lower blower assembly of FIG. 9.

### DETAILED DESCRIPTION

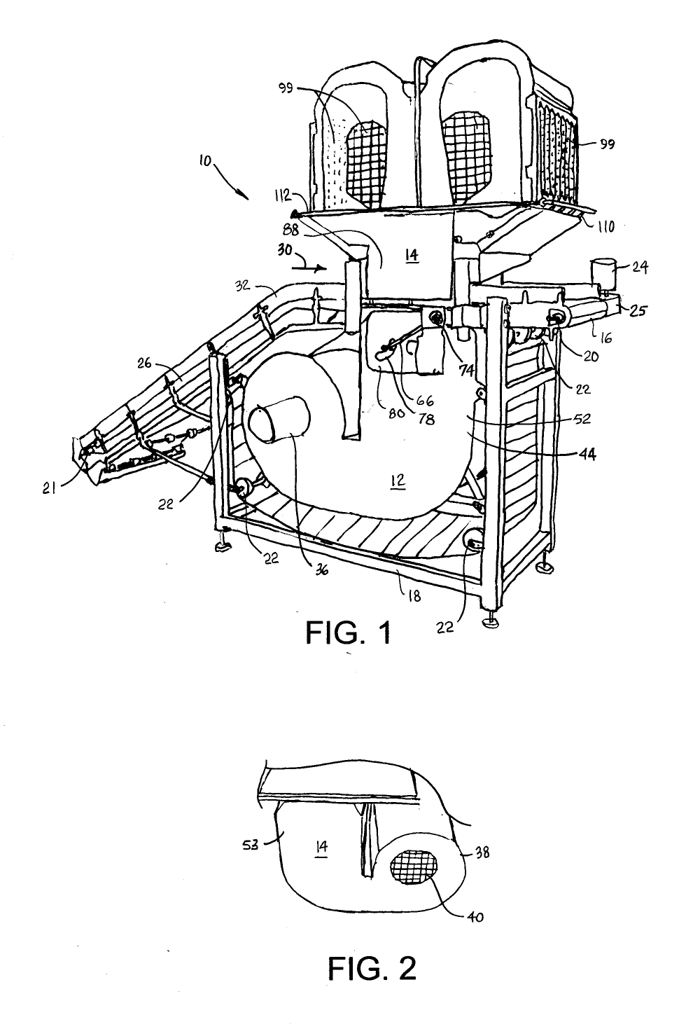

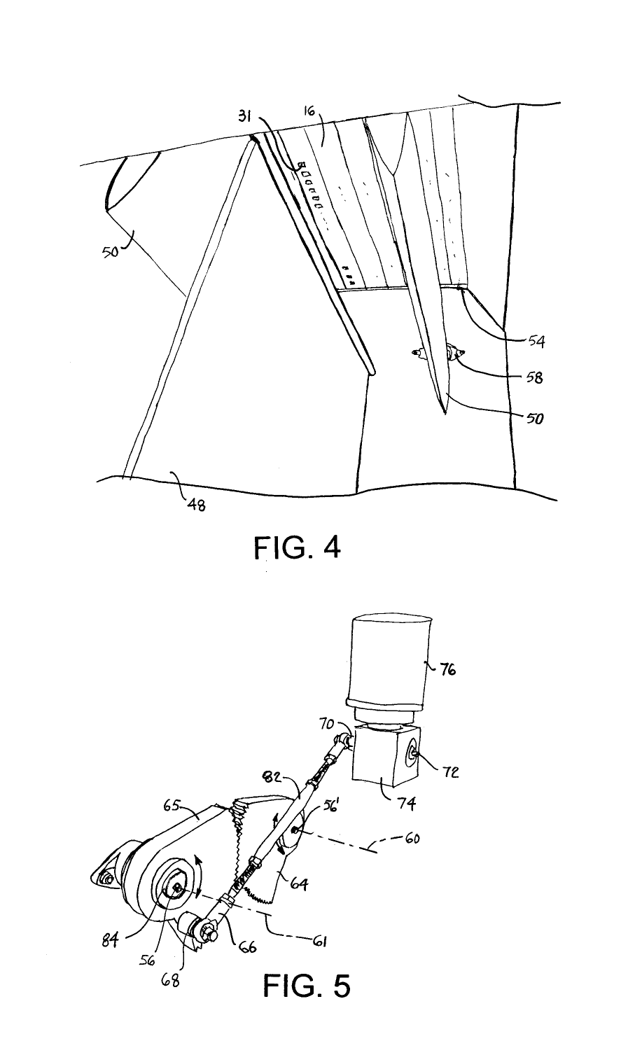

One version of an air separator embodying features of the invention is shown in FIGS. 1-3. The air separator 10 comprises a lower blower assembly 12 and an upper waste separation assembly 14 on opposite sides of a carryway portion 15 of a conveyor, such as a conveyor belt 16. The two assemblies are mounted in a frame 18 that also supports the conveyor. In this example, the conveyor belt 16 is trained around drive sprockets (not shown) on a drive shaft 20 and an idle shaft 21 and around idle rollers 22 in a lower return run. The belt is driven by a drive motor 24 and a gear box 25 coupled to the drive shaft 20. The belt travels up an inclined section 26 to the upper horizontal carryway 15. The belt is laden with product conveyed along the upper carryway in a conveying direction 30. The conveyor belt 16 is a foraminous belt with many openings 31 (FIG. 4) extending through the belt's thickness. The openings are large enough to allow fluids to drain through the belt and for air to pass upward through the belt into the product. Each opening is small enough to prevent products from falling through. Side rails 32 flank the belt on opposite sides to confine product to the belt.

As shown in FIGS. 1-4 and 6A-D, the lower blower assembly includes a centrifugal fan, or blower 34, driven by a motor 36 such as a variable-speed motor. The blower housing 38 has a screen 40 to cover the air intake 42. The blower 34 blows air out the blower housing into a vertical blower duct 44. The duct may optionally be divided into two parallel sub-ducts 46,47 by an airflow divider 48 that extends across the width of the vertical blower duct.

A pair of elongated vanes 50, or paddles, are mounted between side walls 52, 53 of the blower duct near its top exit end 54. A shaft 56 runs the length of each vane 50 across the width of the blower duct 44. The ends of the shaft are mounted in roller bearings 58 in each side wall 52, 53. The shafts define axes of rotation 60, 61 (FIG. 5) for the vanes that are parallel to each other and perpendicular to the conveying direction 30. When the airflow divider is used, each vane is more or less aligned with one of the sub-ducts 46, 47. The vanes are counter-rotated back and forth to cyclically open and close the duct. When the vanes are open, the air flow is centered across the width of the duct away from the two laterally extending duct walls 62, 63.

One means for cyclically rotating the vanes includes a pair of meshed gear sectors 64, 65 mounted to the ends of the vane shafts 56, 56′ and a crank arm 66 pivotally connected at one end to a pivot pin 68 on one of the gear sectors and to a cantilevered crank 70 at the other end. The crank is mounted to a shaft 72 extending from a gearbox 74. The crank is radially offset from the shaft to follow a circular orbit about the shaft's axis. A motor 76 is coupled to the gearbox to rotate the shaft. The pivot pin 68 extends outward of the gear sectors 64, 65 through a curved slot 78 in a gear cover 80. The orbital motion of the crank 70 causes the gear sector 65 to which it is attached to reciprocate rotationally back and forth about the shaft 56 and rotate the associated vane. The geared coupling with the other gear sector 64 causes the other vane to rotate in the opposite direction from the first vane. In other words, when one vane rotates clockwise, the other rotates counterclockwise, and vice versa. The range of rotation of the vanes can be adjusted by changing the length of the arm 66. As shown in this example, the arm is made length-adjustable by a turnbuckle 82 forming a segment of the arm. A linear actuator could be used to replace the manually operated turnbuckle with an automatically operated length-adjustable segment of the arm. A sensor, such as an angle encoder 84, mounted on one or the other of the vane shafts can be used to provide a signal indicating the angular position of the vanes.

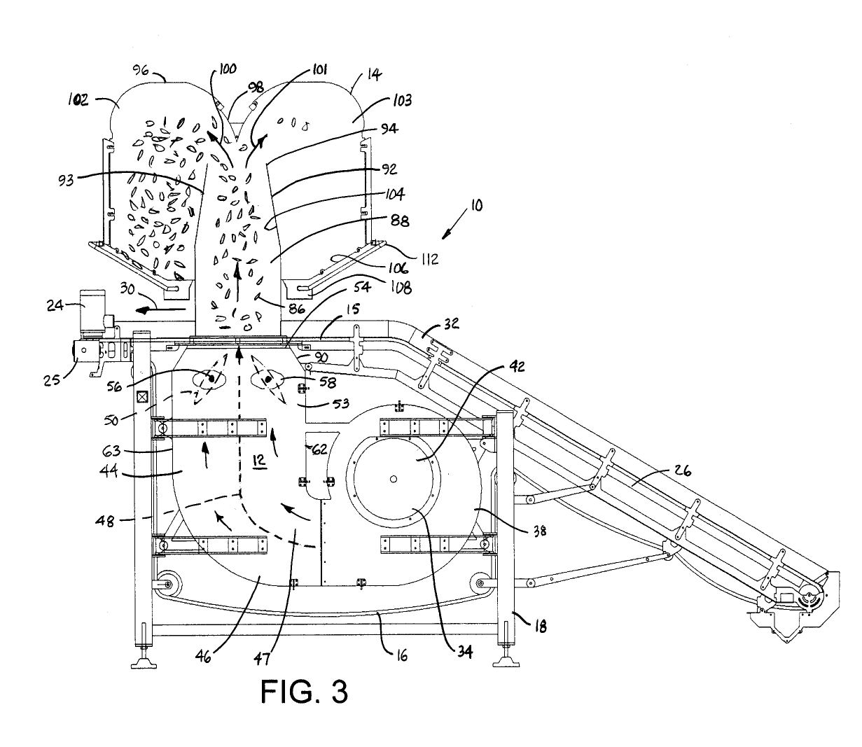

As shown in FIG. 3, the air blown through the foraminous conveyor belt uniformly across its width and through the conveyed product lifts lightweight waste material 86 into a waste conveyor duct 88, which forms a vertical tunnel. The lightweight waste is conducted mainly up a central region of the waste conveyor duct by the centered pulses of air provided by the counter-rotating vanes. The top of the lower duct has a short tapered portion 90 between the vanes 50 and the underside of the conveyor belt 16 to make the exit opening of the lower duct match the entrance opening to the waste conveyor duct 88. Opposite lateral walls 92, 93 of the waste conveyor duct taper inward to narrow the duct in the conveying direction with distance from the conveyor belt. The constricting cross section increases the air speed toward the top end 94 of the waste conveyor duct. An upper hood 96 of the waste separation assembly 14 has an airflow bifurcator 98 centered opposite the top end 94 of the waste conveyor duct to split the air flow and conduct the lightweight waste 86 in two directions 100, 101: one in the conveying direction, the other opposite to the conveying direction. Waste separation chambers 102, 103 on opposite sides of the airflow bifurcator collect the lightweight waste. The sides of the chambers are perforated with many small openings 99 to allow the air, and not the waste, to escape. The waste conveyor duct 88 has a textured surface 104, such as a quilted surface, to prevent moist waste from adhering. A tilted waste pan 106 in each waste separation chamber provides a slide along which the collected waste can slide into a trough 108 and out the chamber through a drain pipe. Fluid nozzles 110 (FIG. 1) direct water onto the tops of the pans 106 to wash the collected waste particles into the trough. The water is supplied via a pipe network 112.

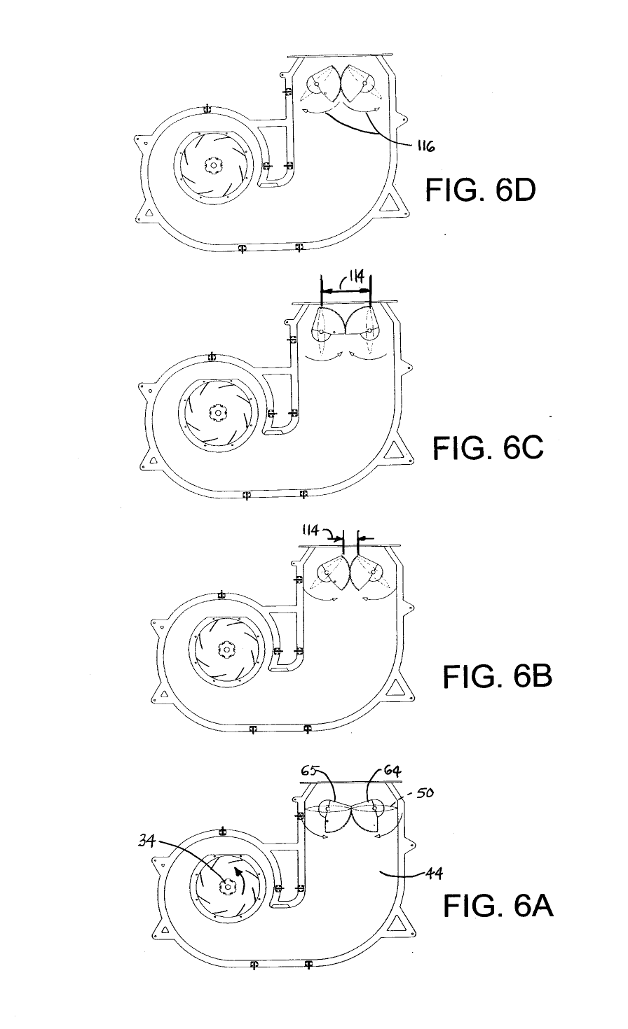

The cyclic operation of the vanes 50 is illustrated in FIGS. 6A-6D. In FIG. 6A, the vanes are shown in a closed position. The two vanes 50 are aligned linearly across the blower duct to block the air flow and build up air pressure below the vanes. When the vanes are closed, the air flow through the belt decreases to a minimum speed of zero. The gear sectors 64, 65 are at one end of their range of rotation. FIG. 6B shows the vanes 50 at an intermediate position on their way from the closed position to the fully open position. In this intermediate position, the central gap 114 between the vanes directs the air flow centrally through the duct. The sudden release of the high-pressure air through the vanes creates a blast of high-speed air along a central region of the duct across its full width. The air continues to flow at a high speed as the gear sectors 64, 65 counter-rotate to the opposite end of their range in the fully open position shown in FIG. 6C, in which the major axes of the cross sections of the vanes are parallel to each other and vertical. In the fully open position, the gap 114 is at its maximum length. At this midpoint in the cycle, the gear sectors start to counter-rotate in the opposite direction, as indicated by the change in sense of arrows 116 in FIG. 6D showing the vanes closing on their way back to the closed position of FIG. 6A to end the cycle and start another. As the vanes close, the air speed decreases from its maximum value. The cyclic opening and closing of the vanes establishes a cyclically pulsing air flow to lift lightweight waste from the conveyed product and blow it through the waste conveyor duct to the two waste separation chambers. Cycle frequencies of between about 60 cycles/minute and 200 cycles/minute have been found to work well with shrimp. Splitting the flow exiting the waste conveyor duct with the bifurcator decreases the maximum path length that any waste particle has to travel to the waste separation chambers. This allows a smaller and less noisy blower to be used. And the centralized air flow lessens the amount of waste that adheres to the walls of the waste conveyor duct.

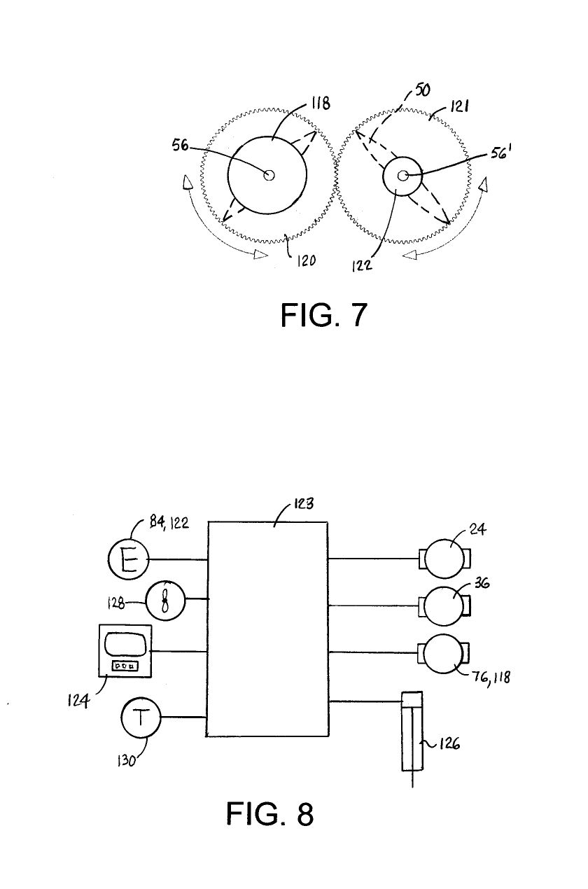

Another means for cyclically rotating the vanes is shown in FIG. 7. In this version, a bidirectional, variable-speed motor 118 drives a first gear wheel 120 meshed with a second gear wheel 121. Each of the gear wheels is mounted to one of the shafts 56, 56′ of the vanes 50. In this way the two vanes can counter-rotate together back and forth between the open and closed positions. The 360° gear wheels also permit the vanes to counter-rotate continuously without the reversal required when the gear sectors 64, 65 of FIG. 5 are used. Of course, 360° gear wheels could replace the gear sectors in FIG. 5, and gear sectors could be used with the motor 118 in

FIG. 7. A shaft encoder 122 can be mounted to the shaft of one of the vanes to provide angular-position feedback.

FIG. 8 shows a control system for automatic control of the air separator. The control system includes a controller 123, such as a programmable logic controller or a laptop, desktop, or workstation computer. A user interface 124 to the controller allows an operator to control and maintain the operation of the air separator. Some of the operating variables the operator can set via the user interface include the speed of the conveyor, the range of rotation of the vanes, the speed or cycle time of the vanes, and the speed of the blower. Based on the operator's settings, the controller outputs signals to the conveyor drive motor 24 to set the speed of the conveyor, the blower motor 36 to control the air flow, the vane motor 76, 118 to control the speed or cycle time or frequency of the vanes and also the range of rotation of the vanes in the case of the motor 118 of FIG. 7, and the range of rotation of the vanes when the adjustable-link portion of the crank arm 66 of FIG. 5 is realized with a linear actuator 126 instead of a turnbuckle. The controller 123 may also receive sensor signals to provide closed-loop control of the air separator. Feedback signals from the shaft encoder 84, 122, an airflow sensor 128, such as an anemometer, and motor-speed sensors 130, such as tachometers, may be used to operate the air separator in a closed-loop system.

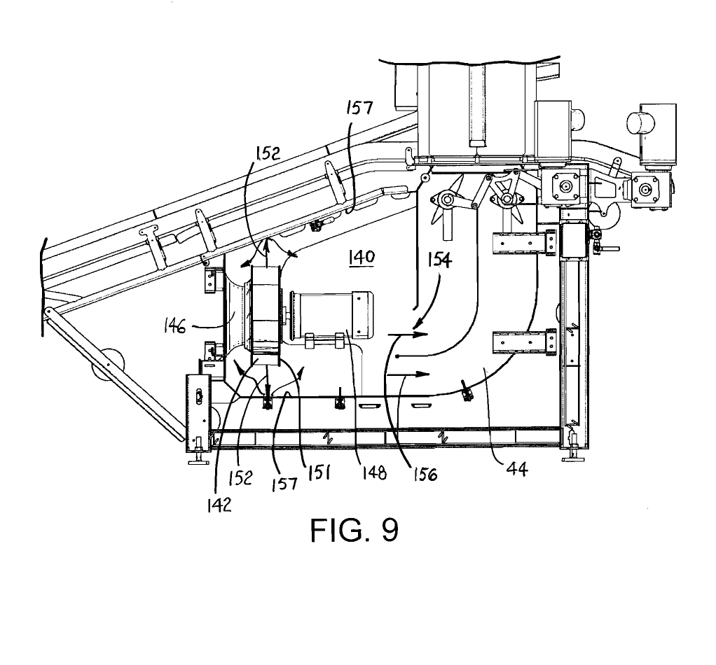

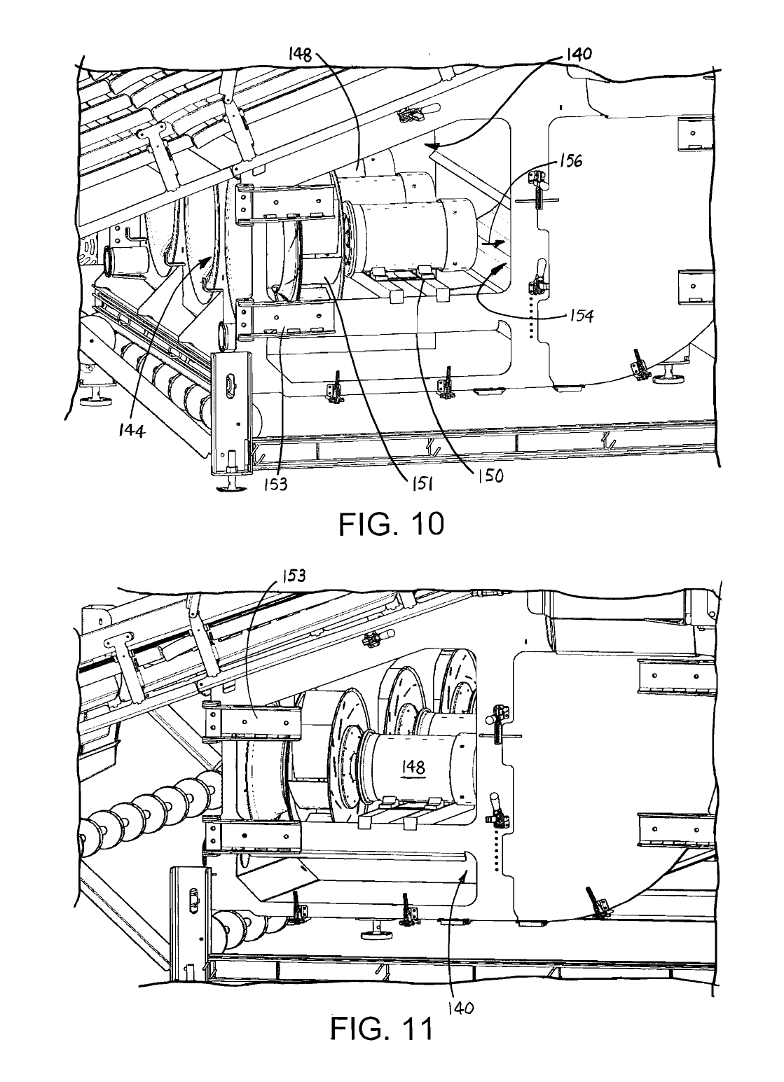

Another version of air supply for the separator is shown in FIGS. 9-11. In this version, a plenum 140 supplies air to the vertical blower duct 44. One or more blowers 142, or fans, mounted in the plenum draw air into the plenum though inlets 144 in the side of the plenum opposite the duct. Inlet cones 146 funnel the air from the inlets to the blowers. Blower motors 148, mounted on mounts 150 in the plenum, rotate the blowers. In the example shown, the blowers have rearwardly inclined vanes on rotors 151 rotated by the motors to direct the exhaust air exiting the blowers along initial direct flow paths 152 in a generally radial direction against the sides, top, and bottom of the plenum to fill it with air. Other kinds of blowers, such as bladed fans or blowers with flat or forwardly inclined vanes, for example, could be used. Doors (not shown), mounted on hinged brackets 153, are closed to cover the sides of the plenum when the air separator is operating and opened to allow access into the plenum for cleaning and maintenance. The air drawn in by the blowers fills and pressurizes the plenum. The plenum 140 communicates with the adjacent vertical blower duct 44 through a plenum exit opening 154 in the common vertical wall 155 of the plenum and the lower portion of the duct. The blowers shown in the example of FIG. 9 direct air along the direct radial flow path 152 that is disrupted by generally perpendicular, rather than parallel, contact with interior walls 157—the top, bottom, and sides—of the plenum so that the direct flow path does not reach the opening 154. The direct flow paths 152 radially exiting the blowers are perpendicular to the horizontal direction 156 of airflow through the opening.

The orientation of the blowers 142 shown in FIGS. 9-11 is 90° from that of the blower 42 of FIG. 3 to prevent the airflow from being guided directly from the blowers to the opening 154. And the plenum 140 has no interior structure that guides air toward the opening. The absence of a direct flow path from the blowers to the opening prevents air velocity variations across the opening. Air is drawn through the opening, not by being blown through, as in FIG. 3, but by the pressure drop from the pressurized plenum to the upper exit end of the vertical duct 44. The pressurized air in the plenum is supplied horizontally through the opening 154 and vertically up the duct 44. The blower 42 in FIG. 3, in contrast, blows air at high speed along a direct flow path into the duct 44, which can cause airflow non-uniformities, or “hot spots.” The high-speed air flung outward by the blower tends to hug the outer wall of the blower housing 38, which results in a non-uniform airflow entering the vertical duct 44 and requires precise positioning of the airflow divider 48 to even out the airflow. Thus, the airflow supplied from the plenum 140 of FIGS. 9-11 by a pressure difference is more uniform across the vertical duct 44 than when the air is blown directly through the opening 154 into the duct from the blowers, as in FIG. 3. The purpose of the blowers in the version of FIGS. 9-11 is to pressurize the plenum without blowing all the air directly into the vertical duct.

To accommodate wider conveyors in the separator of FIGS. 9-11, additional blowers 142 can be mounted in line side by side in a plenum 140 made correspondingly wider to match the conveyor width. For example, if each blower has a 22-inch rotor capable of supplying sufficient airflow for a 24-inch—wide conveyor belt, three blowers could be installed in a correspondingly widened plenum to handle a 72-inch—wide conveyor belt, as in FIGS. 9-11. Thus, the version in FIGS. 9-11 is modular and allows for a horizontally expandable plenum that can house as many blowers as needed for the selected conveyor width. In the version of FIG. 3, a wider conveyor width requires a larger blower. But space limitations may limit the ultimate blower size or require elevating the separator with longer legs. In the modular version, any number of blowers can be installed side by side to accommodate wider conveyors. And only one standard small blower size has to be stocked. Furthermore, a multi-blower system provides some amount of redundancy in case a blower fails. If a blower fails, the failed blower can be blocked and the speeds of the others can be increased to take up the slack. To reduce airflow through the separator, one or more blowers can be turned off or slowed or their inlets blocked.

The air separator described is particularly useful in separating lightweight shrimp peelings, such as shell and head fragments, swimmerettes, and legs, from peeled shrimp meats. But it may also be used in the processing of nuts, grains, fruits and vegetables, and non-food products. Although the air separator has been described in detail by reference to a few versions, other versions are possible. For example, the plenum design can be used in air separators without counter-rotating vanes or even without vanes at all. So the claims are not meant to be limited to the details of the disclosed versions or applications.

What is claimed is:

1. An air separator for separating lightweight waste from product conveyed on a conveyor, the air separator comprising:
a duct having an upper exit proximate the underside of a foraminous conveyor conveying product in a conveying direction;
a plenum adjacent the duct and in communication with the duct through an opening into the duct;
one or more blowers drawing air into the plenum and directing the air in the plenum along a flow path that does not extend to the opening to pressurize the plenum so that the drop in pressure from the plenum to the upper exit of the duct draws air through the opening and through the duct and the foraminous conveyor to blow lightweight waste upward from the product;
wherein the one or more blowers are housed in the plenum.

2. (canceled)

3. An air separator as in claim 1 wherein the one or more motors are coupled to the one or more blowers.

4. An air separator as in claim 1 wherein the direct flow path exiting the one or more blowers is radially perpendicular to the direction of airflow through the opening into the duct.

5. An air separator as in claim 1 wherein the plenum has a top, a bottom, and sides and wherein the direct flow path exiting the one or more blowers is directed to the top, bottom , and the sides to disrupt the direct flow path.

6. An air separator as in claim 1 comprising a plurality of blowers arranged side by side across the width of the plenum.

7. An air separator as in claim 6 wherein the number of blowers and the width of the plenum correspond to the width of the foraminous conveyor.

8. An air separator as in claim 1 further comprising one or more controllable vanes in the duct to control the airflow at the upper exit of the duct.

9. A method for separating lightweight waste from product, comprising:
conveying product over the exit end of the duct of an air separator on a foraminous conveyor belt;
pressurizing a plenum by blowing air drawn into the plenum with one or more blowers housed in the plenum along an initial flow path not extending to an opening from the plenum into an entrance end of the duct;
blowing lightweight waste upward from the product by drawing air through the opening and through the duct and the foraminous conveyor by the drop in pressure from the pressurized plenum to the upper exit of the duct.

10. The method of claim of claim 9 comprising directing the initial flow path radially perpendicular to the direction of airflow through the opening into the duct.

11. The method of claim 9 comprising disrupting the flow path by directing the initial flow path against interior walls of the plenum.
